(19) United States
(12) Patent Application Publication
(10) Pub. No.: US 2026/0080872 A1
(43) Pub. Date: Mar. 19, 2026

(54) VOICE-ACTIVATED ASSISTANCE CALL SYSTEM AND PROCESS

(71) Applicant: GOPI, CORPORATION, Dallas, TX (US)

(72) Inventors: Robert Cresswell Kaiser, Dallas, TX (US); Siddhesh Chavan, Richardson, TX (US)

(21) Appl. No.: 19/327,982

(22) Filed: Sep. 12, 2025

Related U.S. Application Data
(60) Provisional application No. 63/694,830, filed on Sep. 14, 2024.
(60) Provisional application No. 63/743,190, filed on Jan. 8, 2025.

(51) Int. Cl. G10L 15/22; G08B 3/10

(52) U.S. Cl. CPC G10L 15/22; G08B 3/1008; G10L 2015/223

(57) ABSTRACT

In one embodiment, there is a voice-activated nurse call device comprising a processor, a memory, a microphone, a speaker, and an indicator that are housed such that the device couples to a nurse call control station socket found in hospitals and nursing homes.

### CROSS REFERENCE TO RELATED APPLICATIONS

This application claims the benefit of the filing date of U.S. provisional patent application Ser. No. 63/694,830, filed on Sep. 14, 2024, entitled “Voice Activated Bedside Nurse Call Device,” and U.S. provisional patent application Ser. No. 63/743,190, filed on Jan. 8, 2025, entitled “Voice-Activated Assistance Call System,” the disclosures of which are incorporated herein by reference for all purposes.

### TECHNICAL FIELD

The invention relates in general to communication systems in the healthcare field and, in particular, to voice-activated nurse call systems and processes.

### BACKGROUND INFORMATION

Nurse call button systems are vital tools in healthcare settings, allowing millions of patients worldwide to call for potentially lifesaving assistance every day. These systems originated in the 1850s during the Crimean War. The very first nurse call system was implemented by Florence Nightingale, who is regarded as the ‘founder of modern nursing’. The first systems were more primitive than those used today, but they have seen significant improvements in the 20th century. In the beginning, calling for a nurse was very simple with just some sort of bell and pull cord to alert caregivers, but since the 1960s and 1980s, the addition of buttons and other fundamental parts of nurse call systems have not changed significantly. These systems find seamless usage for those who are able to physically activate them, but their effectiveness is limited for those with severe mobility impairments.

While traditional nurse call button systems have been integral to healthcare communication for decades, patients with mobility impairments face significant challenges in utilizing available nurse call button models, which usually require some form of physical pressure to activate. What is needed is a nurse call device that allows patients with severe mobility issues to notify a nurse's station when they need assistance or help.

The features and advantages of the present disclosure will be readily apparent to those skilled in the art. While numerous changes may be made by those skilled in the art, such changes are within the spirit of the invention.

### SUMMARY

In response to these and other problems, in one embodiment, there is a voice-activated nurse call system or device comprising a processor, a memory, a microphone, a speaker, and an indicator which are housed such that the device couples to a nurse call control station socket found in hospitals and nursing homes.

These and other features and advantages will be more clearly understood from the following detailed description taken in conjunction with the accompanying drawings. It is important to note that the drawings are not intended to represent the only aspect of the invention.

### BRIEF DESCRIPTION OF THE DRAWINGS

FIG. 1 is a functional schematic diagram illustrating one embodiment of various functional components of a nurse station call or notification device.

FIG. 2A is a perspective illustration of one example embodiment of certain components positioned within and around an enclosure.

FIG. 2B is a perspective illustration of one embodiment of the enclosure of FIG. 2A.

FIG. 2C is a front view of one embodiment of an external nurse call station, which is typically coupled to a wall.

FIG. 2D illustrates one embodiment of a nurse station notification device coupled to the nurse call station of FIG. 2C.

FIG. 3 is a process flow diagram illustrating one embodiment of processing steps that may be employed in an exemplary nurse station notification system.

FIG. 4 is a process flow diagram illustrating one embodiment of a sub-processing routine that may be employed in an exemplary nurse station notification system.

FIG. 5 is a process flow diagram illustrating one embodiment of a sub-processing routine that may be employed in an exemplary nurse station notification system.

FIG. 6 is a process flow diagram illustrating one embodiment of a sub-processing routine that may be employed in an exemplary nurse station notification system.

FIG. 7 is a process flow diagram illustrating one embodiment of a sub-processing routine that may be employed in an exemplary nurse station notification system.

### DETAILED DESCRIPTION

Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry or mechanisms used to control the function of the various elements described herein are omitted, as such control circuits are within the skills of persons of ordinary skill in the relevant art.

The present invention relates to the field of integrated circuits and nonvolatile memory devices. To illustrate the invention, a specific example and configuration of an integrated circuit and memory cell is illustrated and discussed. It is understood, however, that this specific example is only provided to teach the broader inventive concept, and one of ordinary skill in the art can easily apply the teachings of the present disclosure to other magnetic and/or electrical circuits and structures. Also, it is understood that the integrated circuit and memory cell discussed in the present disclosure include many conventional structures formed by conventional processes.

When directions, such as upper, lower, top, bottom, clockwise, or counter-clockwise, are discussed in this disclosure, such directions are meant only to supply reference directions for the illustrated Figures and for the orientation of components with respect to each other or to illustrate the Figures. The directions should not be read to imply actual directions used in any resulting invention or actual use. Under no circumstances should such directions be read to limit or impart any meaning into the claims.

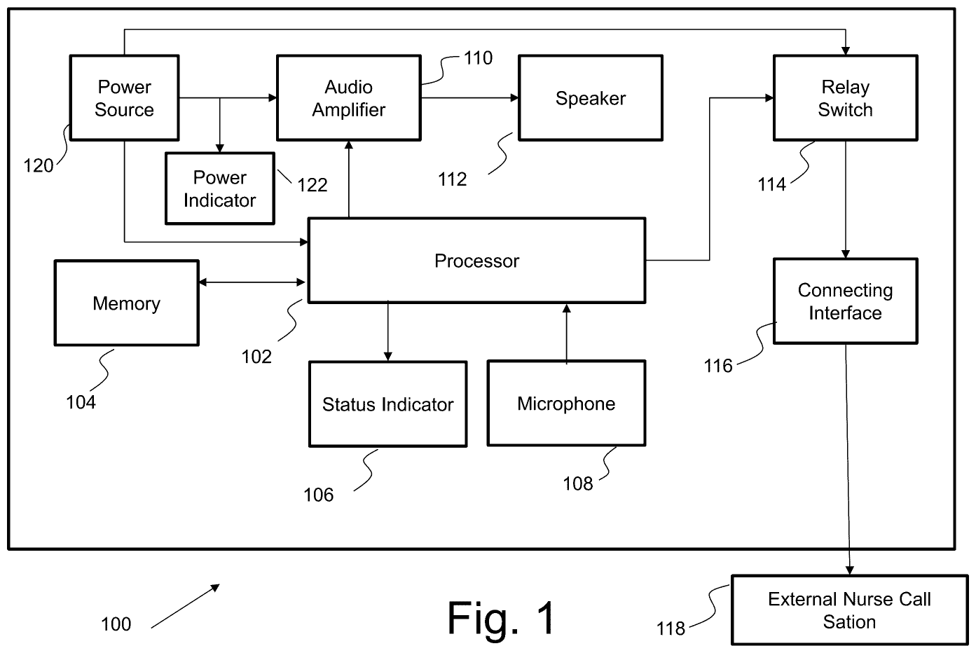

FIG. 1 is a functional schematic diagram illustrating one embodiment of a nurse station notification device or system 100. In an example embodiment, the components of the nurse station notification device 100 are a processor 102, a memory 104, a status indicator 106, a microphone 108, an audio processor or amplifier 110, a speaker 112, a relay switch 114, and a connecting interface 116. In certain embodiments, a power source 120 sends electrical power to the processor 102, the relay switch 114, and a power indicator 122.

In certain embodiments, the processor 102 may be a Raspberry Pi Zero 2W microcontroller. In an exemplary embodiment, the Raspberry Pi Zero 2W Microcontroller has a compact size (65 mm×30 mm), sufficient processing power, but low power consumption. Such a processor allows for real-time voice recognition and control of multiple components, such as the indicator 106, the microphone 108, the speaker 112, and relay switch 114.

In certain embodiments, a memory 104 is in communication with the processor 102. In certain embodiments, the memory may be RAM coupled to the processor or an external memory device in communication with the processor 102. For instance, in certain embodiments, the memory 104 may be flash memory on an external SD card (Secure Digital) in communication with the processor 102 and may be of a type of non-volatile memory that retains data even when power is removed. In certain embodiments, both an operating system and application software may be stored in the memory 104.

In certain embodiments, the processor 102 is in communication with one or more status indicators 106. In certain embodiments, the status indicator 106 may be one or more multi-color LED lights. For instance, LED lights may be used as visual status indicators and provide visual feedback by displaying multiple colors, indicating the system's status at any given time. In certain embodiments, an LED light changes colors to indicate different states. For instance, green may indicate a successful initial start-up, blue may indicate that the device is in an active listening mode, and red may indicate an action that has been completed. In certain embodiments, the three-color cycle (green, blue, and red) provides users with indicators that there may be system problems. For example, if the LED does not display a green light, it may indicate a problem with the startup and initialization process. This color coding helps the user to quickly identify and troubleshoot any potential issues, which will help to ensure that the device 100 operates properly.

In certain embodiments, the processor 102 receives audio input from a microphone 108. In certain embodiments, the microphone 108 may be a USB-A mini microphone. There are a variety of microphones with extended cable connections that can be used to bring the microphone closer to the patient if needed. In certain embodiments, a connector or port for the microphone may be a USB-C type connector, which allows the microphone to be detached processor or PCB and rotated for maximum reception. In certain embodiments, the microphone may have a direct USB connection or port to the processor. For instance, a Raspberry Pi has a USB connector allowing a microphone to connect to it with minimal latency and high-quality audio input for processing. This feature also allows a user to replace the microphone if needed. For instance, if the patient has a soft voice, the user can replace the microphone with either a more sensitive microphone or one that has an extension cable so that the microphone can be placed closer to the patient.

In certain embodiments, the microphone 108 may also support Inter-IC-Sound (I2S) protocol, which is a serial interface protocol for transmitting two-channel, digital audio as pulse-code modulation (PCM) between integrated circuit (IC) components of an electronic device. In the illustrative embodiment, the processor 102 receives the digital audio signals from the microphone 108 in the form of bit streams. The bit streams are analyzed by speech recognition software and acted upon by the processor, as will be described below.

As described below, the processor 102 sends audio signals to an audio processor and/or audio amplifier 110, which will, in turn, send enhanced and amplified audio signals to the speaker 112 for audio playback and confirmation. In certain embodiments, the audio amplifier 110 supports a serial bus standard Inter-IC-Sound (I2S) and may only carry digital audio signals. In certain embodiments, the audio amplifier 110 receives a stored wav file (Waveform Audio File Format) from memory 104 which is a raw, uncompressed audio data representing what will be played on the speaker. The wav files are reconstructed into smooth digital representations and converted into analog audio. In certain embodiments, the audio amplifier 110 is Class D amplifier which is power efficient and resistance matched. The audio amplifier 110 minimizes analog interference and improves audio quality to the speaker.

The speaker 112 is in communication with the amplifier 110 via communication connectors, such as wires, and provides auditory feedback designed to confirm actions, such as a call for assistance. Thus, the speaker 112 provides auditory feedback to complement the visual feedback of the status indicator 106 or LED lights, allowing patients to receive confirmation of their call for a nurse. In certain embodiments, a 3-watt 8 Ohm mini speaker may be used for superior sound quality.

In certain embodiments, the processor 102 is also in communication with a relay switch 114. In certain embodiments, the relay switch 114 may be a single pole, double throw relay that allows the control of one input circuit between two output circuits. In certain embodiments, a 5 V or 12 V relay switch 114 may be used for compatibility with different processors. When used with an existing nurse call station, the relay switch is normally open. When activated by the processor 102, it connects the NC with the COM and closes the relay switch completing the circuit within the connecting interface.

In certain embodiments, when activated by the processor 102, the relay switch 114 can close a circuit by electrically connecting a terminal labeled NC (a short name for Normally Closed terminal) with the other terminal labeled COM (a short name for the common terminal). When such an electrical connection is made, the circuit that activates the external nurse call system is completed. A second position involves a terminal labeled NO (a short name for normally open) which is always connected with the terminal labeled COM, indicating that a connection is not completed within the connecting interface. It switches to the NC position when activated by the processor 102.

When the processor 102 sends the appropriate signal, the relay switch 114 switches from the normally open condition to the normally closed position. This closure completes a circuit via the connecting interface 116, which results in a notification to the nursing station as described below.

In certain embodiments, the connecting interface 116 may be a ¼-inch, single tip jack or 6.35 mm jack, which refers to a cylinder diameter and is separated by a thin insulating ring (e.g., a TS (Tip-Sleeve) connector. The tip is the plus and the sleeve is the ground. The tip or positive side is electrically connected to the NC (normally closed) side of the relay switch 114, and the sleeve is connected to the COM side of the relay switch 114. The jack is designed to be inserted into a port on an external nurse control station 118. In many situations, the external nurse control station 118 is located on a wall in the patient's room. The use of a jack provides compatibility with the standard 6.35 mm wall plate used in many hospital and nursing care facilities, allowing for seamless integration and ease of installation with a pre-existing external nurse call system.

In certain embodiments, a power source 120 supplies power to the various system components. In one embodiment, the power source 120 is electrically coupled to the processor 102, the relay switch 114, the audio amplifier 110, and a “power on” indicator 122. In certain embodiments, the power source 120 may be a power cord from an AC/DC electrical transformer, which is designed to be directly plugged into an AC outlet in the patient's room.

When the device 100 is turned on and/or plugged in, the “power on” status LED 122 may light up to indicate to the user that the device 100 is receiving power.

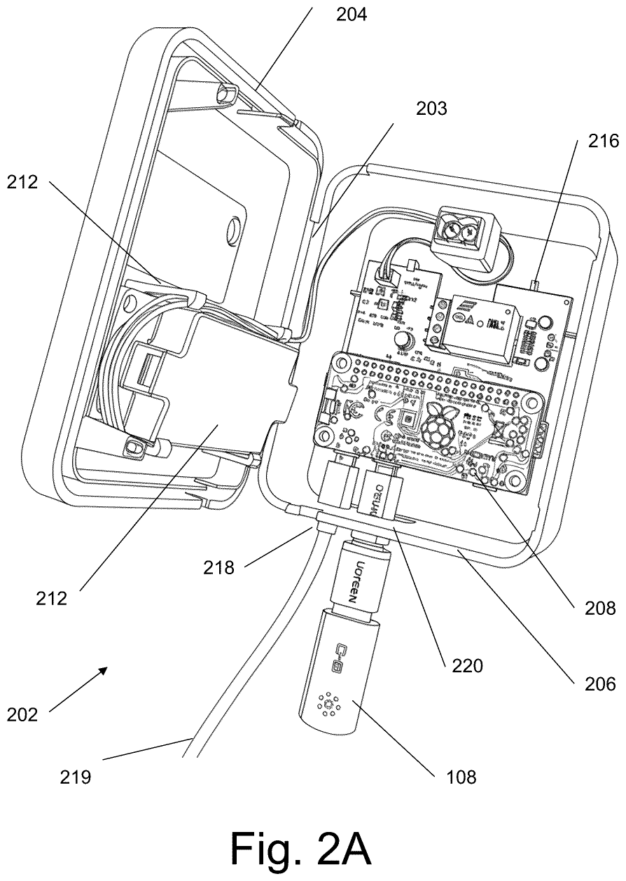

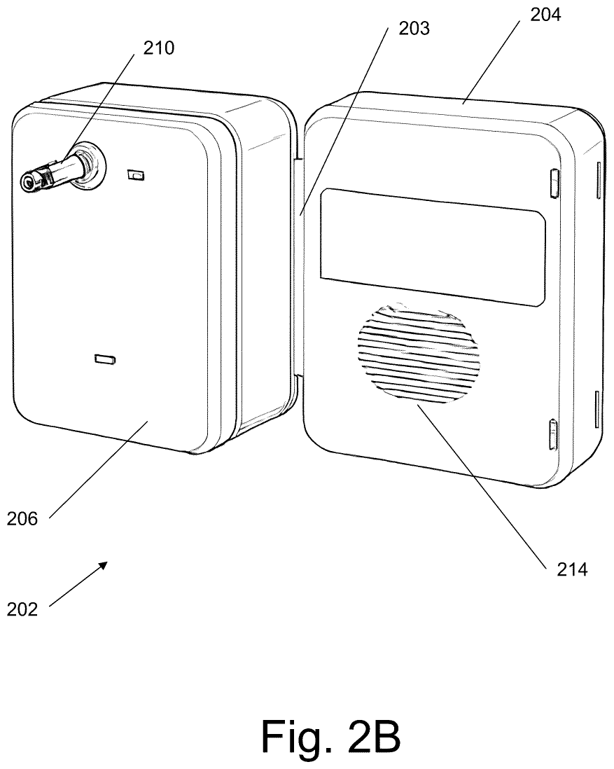

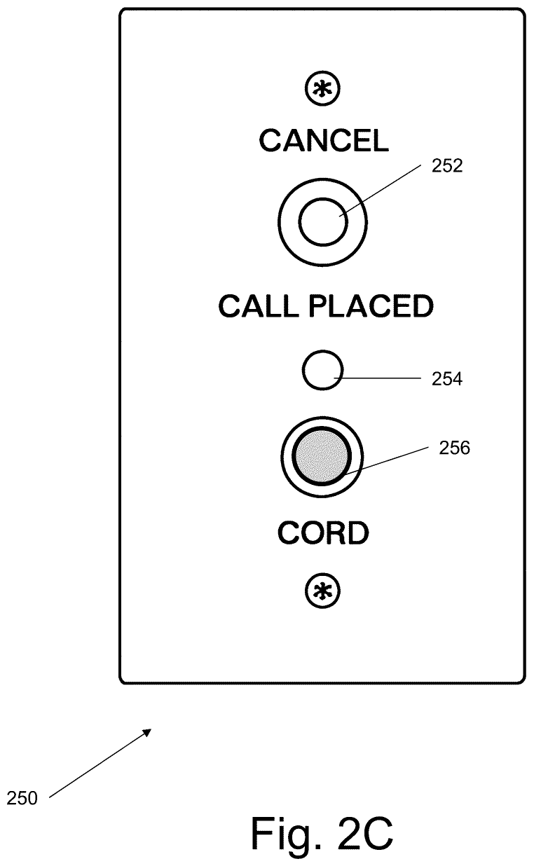

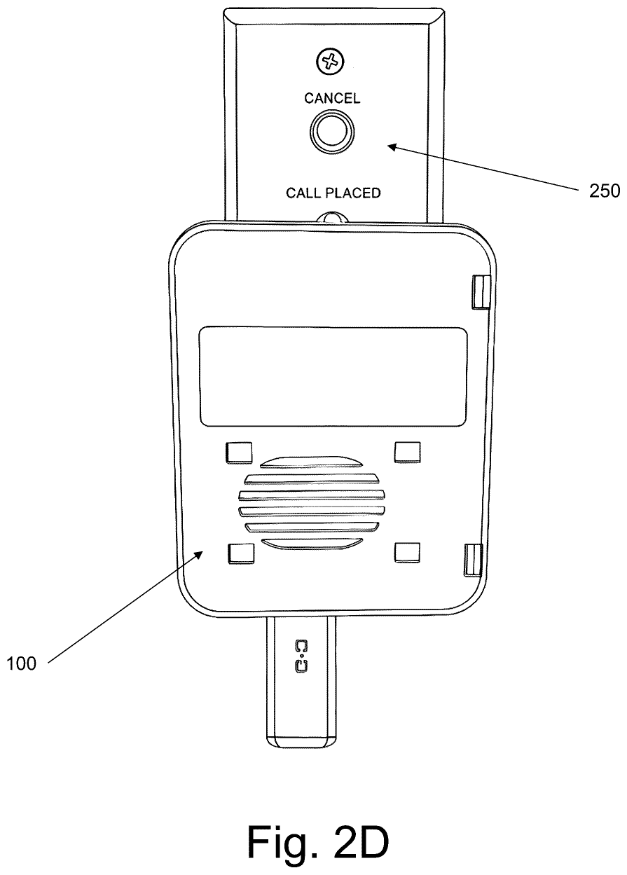

FIG. 2A is a front perspective illustration of one example embodiment of certain components positioned within and around an enclosure 202. FIG. 2B is a rear perspective illustration of one embodiment of the enclosure 202. As illustrated in FIGS. 2A and 2B, the enclosure 202 has a door or top portion 204 and a base or bottom portion 206 coupled together with a hinged portion 203 which allows the enclosure to be opened and closed. In certain embodiments, the enclosure 202 is formed from a polypropylene molded process. In yet other embodiments, the enclosure may be 3D printed using a suitable material known in the art.

Inside the enclosure 202, many of the components discussed above may be arranged compactly and organized onto a custom-designed printed circuit board (“PCB”) 208 to maximize space and ensure easy access and assembly.

As indicated by FIG. 2B, a jack 210, such as a 6.35 mm jack discussed above may be strategically integrated into the rear face of the device 100, enabling direct mounting onto a receiving port (not shown) of the external nurse control station 118. In certain embodiments, the speaker 112 may be coupled to the door 204 using pre-molded flexible clips 212, which are integral with the door as illustrated in FIG. 2A. In certain embodiments, the door 204 may have slots 214 (FIG. 2B) defined therein that allow the speaker 112 to transmit sound through the door portion 204 more efficiently.

In certain embodiments, the PCB 208 and other components may be retained in the base portion 206 by flexible clips 216, which are integral with the base portion. The use of such flexible clips 216 greatly simplifies the fabrication process because most of the components can simply “click”into place without the need for tools.

In certain embodiments, the base portion 206 has a lower port 218 which allows one end of the power line or cable 219 from the AC/DC transformer (not shown) discussed above to couple to a power port on the PCB 208. In certain embodiments, an opening 220 in the enclosure 202 allows the microphone 108 to extend outside of the enclosure 202 so that the microphone can deliver a better acoustical response that is not encumbered by the enclosure 202.

FIG. 2C illustrates one embodiment of a face plate 250 of an external nurse control station 118. In the embodiment of FIG. 2C, there is a “CANCEL” button 252 which allows a user to cancel the call placed to the nurses'station. Once a call is placed, there may be a light 254 which visually notifies the user that the nurse has been called. As discussed above, there may also be a female port 256 which accepts the jack 210 discussed above.

FIG. 2D is a perspective view of the device 100 coupled to the face plate 250 of the external nurse call station 118 via the jack 210 (FIG. 2B) and port 256 (FIG. 2C).

A typical call button (not shown) connects via wires to a jack similar to the jack described above, and the jack is typically inserted into the port 256 of the external nurse control station 118. When a patient presses the call button, it closes an electrical circuit (similar to turning a switch on), allowing current to flow through the wired nurse call system via the jack and port of the external nurse control station. This electrical signal (via current) is then sent to the central control unit or monitor at the nurses'station. The central control unit then processes the signal and activates visual or auditory alerts at the nurses'station to alert the nursing staff that assistance is needed in a specific patient room.

Similarly, as described in detail below, when the microphone 108 picks up the appropriate voice commands, the processor 102 interprets these commands and instructs the relay switch 114 to close the circuit. When the circuit is closed, an electrical signal (via current) is then sent to the central control unit or monitor at the nurses'station. The central control unit then processes the signal and activates visual or auditory alerts at the nurses'station to alert the nursing staff that assistance is needed in the patient's room.

### Operation

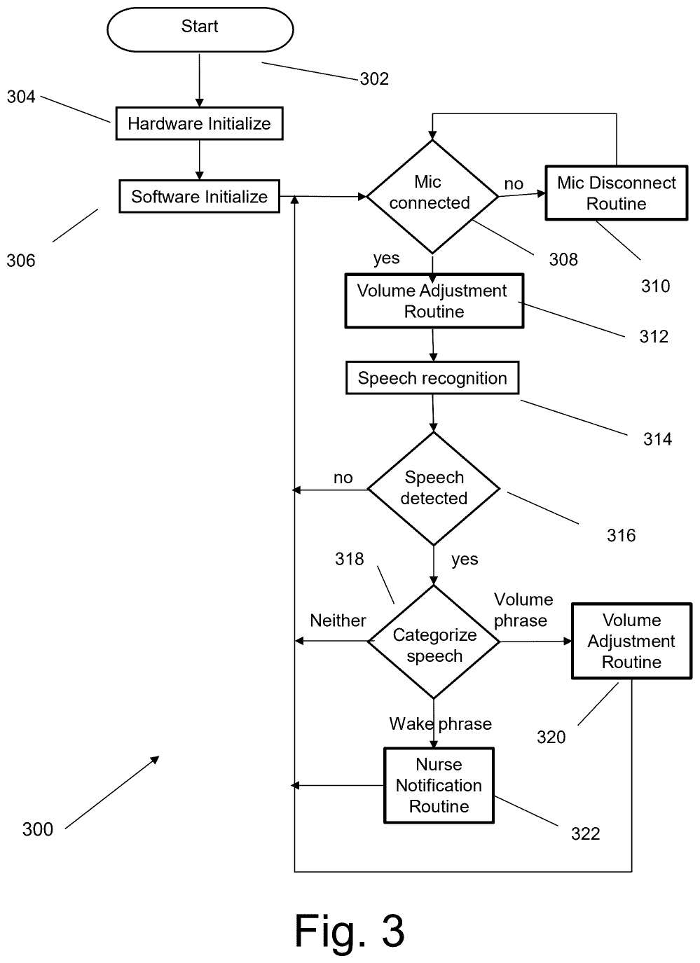

FIG. 3 is an example flowchart that illustrates a process 300 that may be executed on the device 100. In step 302, as part of a start-up step, the power indicator (e.g., a white LED) is activated before any further hardware is initialized. The white LED confirms to the user that power is available directly to the components that require it. Those components being the processor 102, the audio amplifier 110, the relay switch 114, and the power indicator 122.

In step 304, a hardware initialization process begins and is specific to the processor and other hardware elements. In certain embodiments, the hardware initialization may be performed by the Debian Linux-based operating system, which is stored in memory and configures the hardware elements of the processor. See more detail in the software initialization.

In step 306, a software initialization routine starts by loading the operating system from the memory 104. This routine identifies all items that are available on the processor and deactivates the items that are not required by the system. Those items that are not required may be Bluetooth, WI-FI, HDMI video, and any excess audio channel. Then routine then activates the USB Microphone 108 and identifies support for Inter-IC-Sound (I²S) which is used for the microphone and audio amplifier 110. The operating system now loads additional processes in the form of application software—which in an example embodiment is Python based. In certain embodiments, the status indicator 106 (i.e., the status LED) turns green to indicate the application is being loaded. The application subsequently loads the Vosk speech recognition library. At a startup phase, the application sets a Boolean variable “start-up’ to TRUE, which is used later in the application to indicate if it is a first time on status. The first time on status allows certain customization features to be enabled as will be discussed below.

In step 308, the microphone 108 status is managed by the operating system which provides an indicator to the process that the microphone present. This is accomplished by constantly evaluating a bit stream output from the mic. This is a system check for the process which requires a working microphone to function properly.

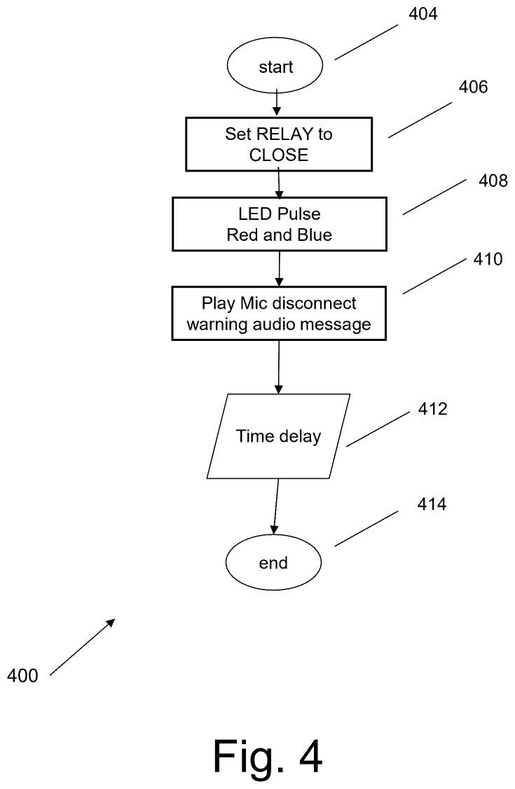

In step 310, if the microphone 108 is deemed to be missing, a subprocess 400 is executed as discussed below in reference to FIG. 4. The steps 308 and 310 form a continuous loop until a microphone 108 is attached.

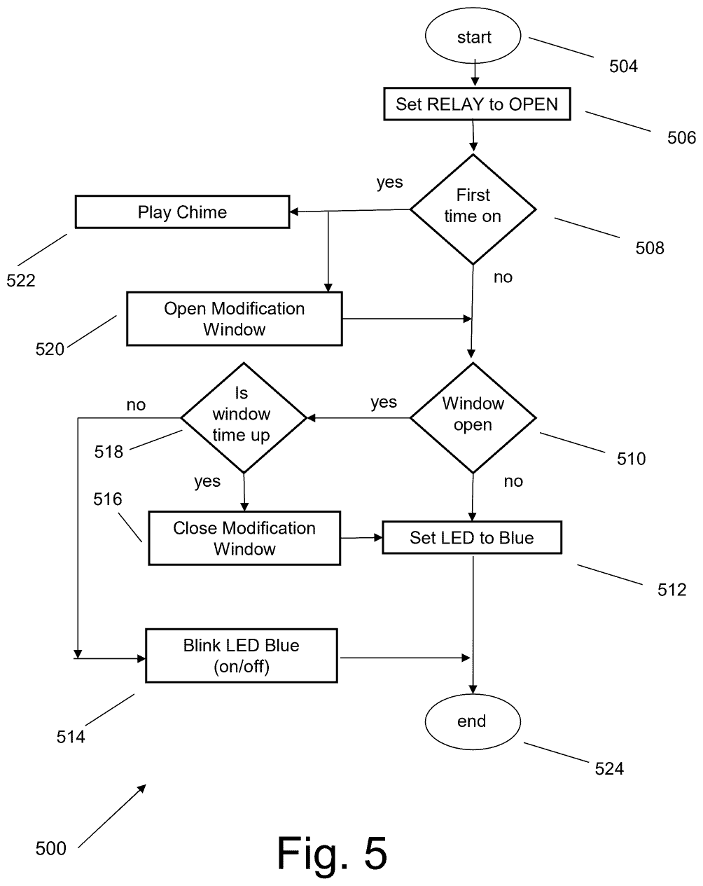

In step 312, once the process has confirmed that the microphone 108 is connected, the process flows to a sub-process 500, which allows for the adjustment of the speaker volume. The sub-process 500 is discussed in detail in reference to FIG. 5 below.

In step 314, the system implements Vosk which is a practical speech recognition library which comes with a set of accurate models, scripts, practices and provides ready to use speech recognition for different platforms like mobile applications or Raspberry Pi. The Vosk software is the key element used to turn microphone audio into text. Instead of using a large 20,000 word grammar library, Vosk is configured to focus on a small grammar library. This allows the process to run faster and more accurately to identify key phrases (sometimes referred to as wake phrases). In certain embodiments, the process uses a small library of approximately fifty specially selected common words which include the key phrases. Vosk will identify the specific key phrases used to activate the device 100. In a similar fashion, Vosk will identify the specific key phrases used to adjust the speaker volume. It requires less time and computational energy to identify the key phrases from the smaller grammar library when compared to a much larger library. This smaller grammar also reduces false positives, which are defined as words that are mistaken as key phrases.

In step 316, the detection sequence starts with the microphone that creates a bit stream directed to Vosk. The bit stream constitutes data for the language model. The language model performs analysis and derives the key phrases using an acoustic model which is a deep neural network trained to map waveforms into phonemes. Phonemes are the basic building blocks of spoken language. This is followed by a grammar language model that predicts which words are likely, so the output isn't gibberish. The matched words are determined to be key phrases to activate the device 100 or key phrases to adjust the speaker volume. The process takes appropriate action based on the match.

In step 318, the process then categorizes any identified key phrases and determines whether there are keywords used to indicate that the patient needs help. For instance, if a wake phrase or keyword is recognized, the process moves to step 322. If a volume phrase or keyword is recognized, however, the process moves to step 320.

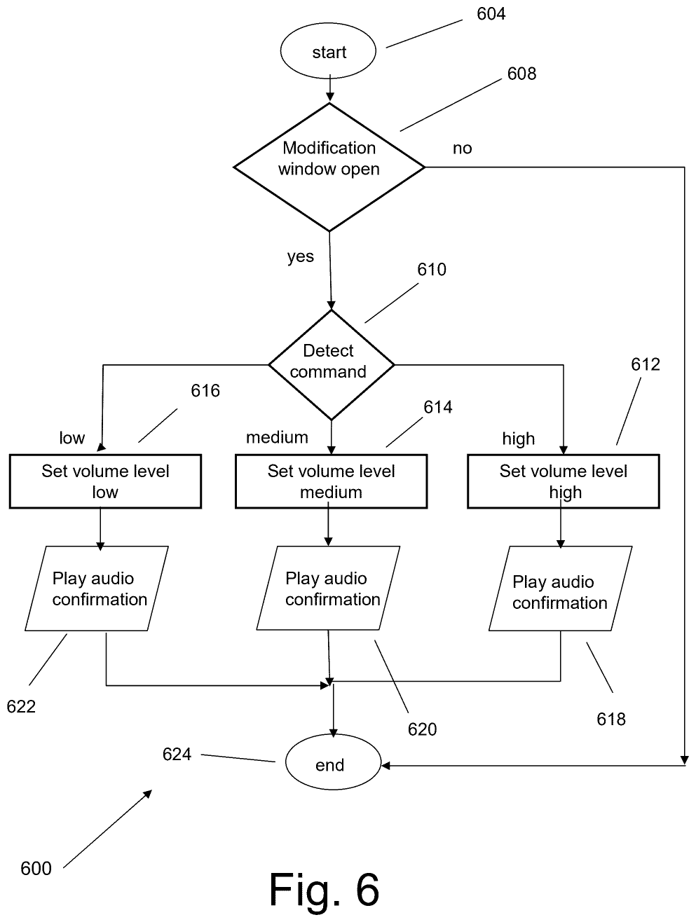

In step 320, when the key phrase for volume adjustment is detected, a volume adjustment routine is performed and an audio message is played on the speaker. One such embodiment of a volume adjustment routine is the subprocess 600 below in reference to FIG. 6. Once the volume adjustment routine is complete, the process performs a loop and control moves back to step 308 to continue to listen for keywords.

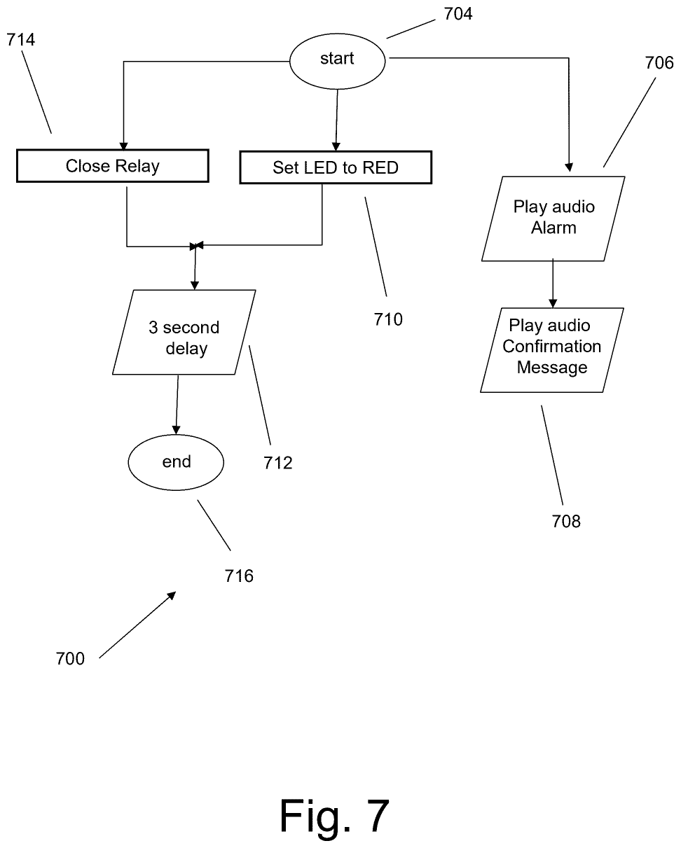

In step 322, a sub-process 700 for alerting the nurse's station is executed as described below in reference to FIG. 7. Once the sub-process 700 is complete, the process loops back to step 308 to continues to listen for keywords.

FIG. 4 is an example flowchart that illustrates a sub-process 400 that may be executed on the device 100. This subprocess 400 creates a unique feature of notifying a nurse's station that there is a missing microphone. If for some reason the microphone is removed, the system will not work and an alert is sent to the nurse's station that the microphone 108 is not connected to the device 100. The subprocess starts in step 404 and continues to step 406.

In step 406, the first step is to close the relay switch 114 which in turn activates the call light as if the patient had called for help. In step 408, The LED status light 106 now pulses from RED to BLUE. In step 410, a message is played on the speaker warning that the microphone is missing. In step 412, a short pause is created because this loop will continue to run until the microphone is attached. The system does not require a restart once the microphone has been attached.

In step 414, the sub-process 400 ends and control is returned to the main process 300 discussed above in reference to FIG. 3.

FIG. 5 is an example flowchart that illustrates a sub-process 500 that may be executed on the device 100 to allow the adjustment of the speaker volume. The adjustment process is only performed during a short window of time when the system is first turned on. The BLUE LED flashes during the short window. There are three speaker volume levels (low, medium and high) and are enabled by using key phrases. This is very similar to the process that occurs with the help alarm key phrases. Audio messages are played on the speaker that confirm which volume level has been selected.

In step 504, the sub-process 500 is started, and the process flows to step 506.

In step 506, the relay is set to an OPEN state as described above.

In step 508, the process checks to see if the current state is a “first time on” by looking at the Boolean variable “startup”to see if the variable is TRUE.

In step 510, the window to adjust the volume is preset to a fixed period of time. If that time has expired, the change in speaker volume cannot be made.

In step 518, this checks the timer status. If there is still time. the process goes to step 514. If the time has expired, then process goes to step 516,

In step 512, set the LED to BLUE and return to the main loop of the process in step 524.

In step 516, the modification window is closed because the time has expired and the process proceeds to step 512.

In step 514, the BLUE LED blinks on/off, and the process returns to the main loop of the process.

In certain embodiments, step 520 happens simultaneously with step 522. Since it is the first time the unit has been turned on, the volume change for the speaker is allowed. The timer window is opened, and a chime is played.

In step 524, the sub-process 500 ends and control is returned to the main process 300 discussed above in reference to FIG. 3.

FIG. 6 is an example flowchart that illustrates a sub-process 600 that may be executed on the device 100 to allow the adjustment of the speaker volume during monitoring.

In step 604, the sub-process 600 starts and flows to step 608.

In step 608, this loop is established to determine the correct volume level for the speaker. Previously the modification window needed to be open and if it is still open the process can continue. If it is not open, this loop returns to the main loop of the process.

In step 610, if the window is still open, the next step is to read the key phrase that was detected. It was one of three key phrases. Set volume low, medium or high.

In step 612, the audio interface is controlled by a software extension made for Python applications called “pyaudio”. The audio message which is played at 80% volume capacity for the high level.

In step 614, the audio interface is controlled by a software extension made for Python applications called “pyaudio”. The audio message which is played at 50% volume capacity for the medium level.

In step 616, the audio interface is controlled by a software extension made for Python applications called “pyaudio”. The audio message which is played at 20% volume capacity for the low level.

In step 618, an audio message is played to the speaker providing feedback that the volume has been appropriately adjusted to the high level, then returns to the main loop of the process. In step 624, In step 620, an audio message is played to the speaker providing feedback that the volume has been appropriately adjusted to the medium level, then returns to the main loop of the process. In step 624,

In step 622, an audio message is played to the speaker providing feedback that the volume has been appropriately adjusted to the low level, then returns to the main loop of the process. In step 624,

In step 624, the sub-process 600 ends, and control is returned to the main process 300 discussed above in reference to FIG. 3.

FIG. 7 is an example flowchart that illustrates a sub-process 700 that may be executed on the device 100, which results in a notification sent to the nurses'station and confirmation to the user that a signal has been sent to the nurses'station.

The sub-process 700 begins at step 704 and, in certain embodiments, simultaneously flows to steps 714, 710, and 706.

In step 714, this loop occurs because a key phrase for the alarm has been detected. This is the wake phrase that fires off three simultaneous events. One or more of these three events activates the device 100 by closing the relay switch for 3 seconds which has always been open until now.

In step 710, another one of these events is the LED turning RED for 3 seconds.

In step 706, an audio alarm sound is played to bring attention that an audio confirmation message is about to be played.

In step 708, an audio message is played to the speaker providing feedback that the volume has been appropriately adjusted, then returns to the main loop of the process.

In step 712, both the LED being RED and the relay being closed last for 3 seconds. Once the 3 seconds has passed the relay goes back to being open and the RED is deactivated and then returns to the main loop of the process.

In step 716, the sub-process 700 ends and control is returned to the main process 300 discussed above in reference to FIG. 3.

### ADVANTAGES

Certain embodiments address the above-described problem by providing a user-friendly, reliable, and voice-activated nurse call device. The voice activation feature allows patients with limited mobility to easily call for assistance, while the LED indicator and audio feedback ensure clear and reliable operation and notification.

The device is designed to be small and compact, allowing for a direct connection to the wall jack plate in patient rooms. In some embodiments, there is a standard 6.35 mm wall jack (commonly referred to as a ¼-inch jack), integrated into the device back plate, and positioned with an offset to ensure seamless connectivity without obstructing other essential components. This design prevents interference with the existing elements on the facility's nurse call plate, such as the LED indicator located above the wall jack and the reset button positioned above the LED.

If the device interferes with other components, it can be repositioned to a nearby area and connected with an extension cable that connects to the wall jack. This provides easy adaptation to a variety of nurse call environments, providing a neat and efficient installation.

The abstract of the disclosure is provided for the sole reason of complying with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

Any advantages and benefits described may not apply to all embodiments of the invention. When the word “means” is recited in a claim element, Applicant intends for the claim element to fall under 35 USC 112(f). Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means”are not intended to fall under 35 USC 112(f).

The foregoing description of the embodiments of the invention has been presented for the purposes of illustration and description. It is not intended to be exhaustive or to limit the invention to the precise form disclosed. Many combinations, modifications, and variations are possible in light of the above teaching. For instance, in certain embodiments, each of the described components and features may be individually or sequentially combined with other components or features and still be within the scope of the present invention.

For instance, in some embodiments, there may be a device or system for remotely communicating with a pre-existing nurse call station, the system comprising: a means for receiving, by a processor, digital audio input signals from a microphone in the form of bit streams; a means for detecting specific words from the received bit streams; a means for determining if the specific words include a predetermined wake phrase; if the specific words include a predetermined wake phrase, implementing a means for a nurse call, else returning to the receiving digital audio signals step above, wherein the means for the nurse call includes: a means for sending, by the processor, a signal to close a relay for a short period that is physically coupled to a nurse call station and a means for returning to the receiving digital audio signals step, above.

In some embodiments, there may be the above system wherein the nurse call means further comprises a means for closing the relay for a predetermined period of time to activate the external nurse call system, then a means for opening the relay again.

In some embodiments, there may be the above system wherein the nurse call means further includes: a means for activating a status indicator in electrical communication with the processor; a means for playing a predetermined audio message on a speaker in communication with the processor; a means for waiting a predetermined amount of time; and a means for returning to the receiving digital audio input signals step above.

In some embodiments, there may be the above system, further comprising: a means for determining if the specific words include a predetermined volume phrase.

In some embodiments, there may be the above system, further comprising a means for determining if a microphone is detected, and a means for closing the relay switch and a means for playing an audio message on the speaker stating the microphone is not connected.

Furthermore, undescribed embodiments which have interchanged components are still within the scope of the present invention. It is intended that the scope of the invention be limited not by this detailed description, but rather by the claims.

1. A nurse station communication device, comprising:
a processor,
a memory in communication with the processor,
an audio amplifier in communication with the processor,
a speaker electrically coupled to the audio amplifier;
a microphone electrically coupled to the processor,
a visual status indicator electrically coupled to the processor;
a relay switch in communication with and controlled by the processor,
a connecting interface electrically coupled to the relay switch; and
a power source electrically coupled to the processor, the audio amplifier, and the relay switch,
wherein the memory contains instructions for:
receiving, by the processor, digital audio input signals from the microphone in the form of bit streams;
detecting specific words from the received bit streams;
determining if the specific words include a predetermined wake phrase;
if the specific words include a predetermined wake phrase, implementing a nurse call process, else returning to the receiving digital audio signals instruction step,
wherein the nurse call process includes:
sending, by the processor, a signal to close the relay switch; and
returning to the receiving digital audio signals instruction step, above.

2. The device of claim 1, further comprising a visual power indicator electrically coupled to the power source.

3. The device of claim 2, wherein the visual power indicator is an LED light.

4. The device of claim 1, wherein the connecting interface is a ¼″ two-conductor, single-tip jack.

5. The device of claim 1, wherein the memory instructions further comprise closing the relay switch for a predetermined period of time to activate a nurse call system, then opening the relay switch again.

6. The device of claim 1, wherein the microphone is detachable from the device.

7. The device of claim 1, wherein the visual status indicator is a multi-color LED light.

8. The device of claim 1, wherein the nurse call process further includes:
activating the visual status indicator;
play a predetermined audio message on the speaker;
waiting a predetermined amount of time; and
returning to the receiving digital audio input signals step above.

9. The device of claim 1, wherein the instructions in memory further include:
determining if the specific words include a predetermined volume phrase;
if the specific words include a predetermined volume phrase, adjusting a volume output of the speaker and returning to the receiving digital audio input signals step.

10. The device of claim 1, wherein the instructions in memory further include determining if a microphone is detected, if a microphone is not detected, closing the relay switch.

11. A nurse station communication device, comprising:
a processor,
a memory in communication with the processor,
an audio amplifier in communication with the processor,
a speaker electrically coupled to the audio amplifier;
a microphone electrically coupled to the processor,
a visual status indicator electrically coupled to the processor;
a relay switch in communication with and controlled by the processor,
a connecting interface electrically coupled to the relay switch; and
a power source electrically coupled to the processor, the audio amplifier, and the relay switch.

12. The device of claim 11, further comprising a visual power indicator electrically coupled to the power source.

13. The device of claim 12, wherein the visual power indicator is an LED light.

14. The device of claim 11, wherein the connecting interface is a ¼″ two-conductor, single-tip jack.

15. The device of claim 11, wherein the microphone is detachable from the device.

16. The device of claim 11, wherein the visual status indicator is a multi-color LED light.

17. A method of remotely communicating with a nurse call station, the method comprising:
receiving, by a processor, digital audio input signals from a microphone in the form of bit streams;
detecting specific words from the received bit streams;
determining if the specific words include a predetermined wake phrase;
if the specific words include a predetermined wake phrase, implementing a nurse call process, else returning to the receiving digital audio signals step above,
wherein the nurse call process includes:
sending, by the processor, a signal to close a relay switch physically coupled to a nurse call station; and
returning to the receiving digital audio signals step, above.

18. The method of claim 17, wherein the nurse call process further comprises closing the relay switch for a predetermined period of time to activate an external nurse call system, then opening the relay switch again.

19. The method of claim 17, wherein the nurse call process further includes:
activating a status indicator in electrical communication with the processor;
play a predetermined audio message on a speaker in communication with the processor;
waiting a predetermined amount of time; and
returning to the receiving digital audio input signals step above.

20. The method of claim 17, further comprising:
determining if the specific words include a predetermined volume phrase;
if the specific words include a predetermined volume phrase, adjusting a volume output of a speaker and returning to the receiving digital audio input signals step, above.

21. The method of claim 17, further comprising determining if a microphone is detected, if a microphone is not detected, closing the relay switch and playing an audio message on a speaker stating the microphone is not connected.
